(19) United States
(12) Patent Application Publication
(10) Pub. No.: US 2008/0033727 A1
(43) Pub. Date: Feb. 7, 2008

(54) Method of Supporting The User Of A Voice Input System

(75) Inventors: Alexander Huber, Eching (DE); Jochen Eckert, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/832,263

(22) Filed: Aug. 1, 2007

(30) Foreign Application Priority Data
Aug. 1, 2006 (DE) 102006035780.9

(51) Int. Cl. G10L 11/00

(52) U.S. Cl. 704/275; 704/E15.001

(57) ABSTRACT

In the case of a method of supporting the user of a voice input system by which a quantity of potential voice commands is visually issued to the user, the voice commands are at least partially issued acoustically to the user in a successive manner and, during the acoustic output of a voice command, the same voice command is highlighted in the visual output.

### BACKGROUND AND SUMMARY OF THE INVENTION

This application claims the priority of German Application No. 10 2006 035 780.9, filed Aug. 1, 2006, the disclosure of which is expressly incorporated by reference herein.

The invention relates to a method of supporting the user of a voice input system by which a quantity of potential voice commands is visually issued to the user.

This type of a method is known, for example, from U.S. Patent Document US 2004/0030559 A1 or from German Patent Document DE 100 12 872 C2. The visual output of a quantity of potential voice commands illustrates to the user the options offered to him with respect to the voice input. In the case of a voice input system, these options may always be the same, independently of the situation. However, an output of a quantity of potential voice commands is especially advantageous when it takes place in a context-sensitive manner; that is, when those voice commands that are conceivable in the current situation are issued to the user. Such a context-sensitive output can take place, for example, within the scope of an “inquiry” of the voice input system after a preceding voice command of the user had not been unambiguously understood.

It is a disadvantage of the methods of the initially-mentioned type that the user only has a limited benefit from the visual representation because he is forced to look at the indicating element used for the output in order to recognize the quantity of potential voice commands. Particularly when using voice input methods in motor vehicles, it is not desirable to look away from the traffic situation, because drawing the driver's attention away from the traffic may be connected with considerable risk. It may be dangerous or at least disturbing also in other fields of application for the user to be forced to look at the indicating element showing a quantity of potential voice commands.

It is an object of the invention to provide a simple method of the above-mentioned type by which the user's attention is not diverted as much.

This object can be achieved by a method of supporting a user of a voice input system by which a quantity of potential voice commands is visually issued to the user. According to the method, the voice commands are at least partially issued acoustically to the user in a successive manner and, during the acoustic output of a voice command, the same voice command is highlighted in the visual output.

Since the voice commands, at least partially, are acoustically emitted to the user in a successive manner, the user does not necessarily have to look at the indicating element used for the output. Instead, he can simply hear which options are offered to him.

The invention provides a particularly advantageous combination of the visual and acoustic output of potential voice commands in that, during the acoustic output of a voice command, the same voice command is highlighted in the visual output.

This offers various advantages. Since, by means of the visual and the acoustic output, two sensory procedures of the user are now addressed (seeing and hearing, or visual and auditory), the latter can particularly easily perceive the voice commands issued to him. The potential voice commands are presented to the user, as it were, in a multimedia manner. The multiple advantages of a multimedia presentation are known from perception research.

The invention can stimulate the absorption of the options issued to the user in the user's short-term memory, whereby the user will better remember the previously used options during the subsequent voice input.

The user can follow the multimedia presentation in a very relaxed fashion because, as a result of the redundancy of the multimedia output, he never has the feeling that he may be “neglecting something.” This may have a relaxing effect and/or reduce fatigue, which is particularly significant when the invention is used in motor vehicles.

Since, as a result of the multimedia representation according to the invention, the user is better prepared for the subsequent input of a voice command, the entire required input time can be reduced by the invention.

The simultaneous optical highlighting of the just acoustically emitted voice command, for example, also makes it possible for the user to briefly or lastingly look away from the output element used for the visual output without losing the “red thread” of the presentation. When he then later redirects his view onto the output element used for the visual output, he will immediately learn from the visual highlighting which visually represented voice command is just being emitted acoustically. The user can therefore, for example, recognize at which point the multimedia presentation of the potential voice commands has arrived.

Depending on his preference or on the presence of other acoustic and/or visual diversion sources, the user can optionally completely or predominantly concentrate his attention on the acoustic or the visual output. Thus, despite the additional acoustic output, the user can optionally continue to orient himself predominantly or exclusively on the basis of the visual output. However, as a result of the invention, the user, depending on his preference or depending on the presence of other acoustic and/or visual diversion sources, can, in particular, alternately focus his attention on the acoustic or the visual output. The visual highlighting helps him in each case with respect to orienting himself within this visual output when he returns to it.

The user can learn from the acoustic output how a textually visually displayed voice command is to be pronounced and/or intonated. He is thereby supported when articulating his voice commands and the recognition rate of the voice recognition system is indirectly improved in that the quality of the user's voice commands is improved. This may be particularly advantageous when the user is not fluent in the language set in the voice input system.

According to a preferred embodiment of the invention, the visual output does not directly offer the text of a potential voice command to the user. The visual output may take, for example, a symbol form. In such cases, the acoustic output may instruct the user as to which wording of a voice command is assigned to a certain visually displayed voice command. The user can recognize the assignment by the highlighting according to the invention in the visual output. For example, for the voice command “help,” only a question mark may be displayed in the visual output as a symbol. The acoustic output will then explain to the user that the wording of the pertaining voice command correctly is “help.” Graphic symbols, such as a musical note for the “radio on” voice command, or abbreviations, such as the text “Nebel-SW ein (Fog HL on) for the voice command “Fog Headlight” are also made possible. This considerably improves the freedom of shaping the visual output. For example, the visual output for different voice variants of a user system may also have the same structure. The same (internationally understandable) symbol can be assigned to the voice command “Help” in the case of an English language variant, and to the voice command “Hilfe” in the case of a German language variant.

The freedom of structuring when defining easily differentiable voice commands can also be increased by means of the invention. The assignment according to the invention between an acoustic output and a visual output permits the use of a possibly originally incomprehensible or ambiguous wording of a voice command since the latter is explained by the visual output. For example, for switching on the fog lights of a motor vehicle, the voice command “fog” can simply be defined, if a visual output of the text “fog headlight” eliminates its incomprehensibility.

Particularly in the case of a visual output in a symbol form, it may be advantageous to provide a visual display for at least one voice command (to show a symbol when the output is in a symbol shape) even if the respective voice command is currently not available. This facilitates the visual orientation for the user. The existing or non-existing availability can optionally be illustrated by a variation of the visual output; thus, for example, by an additional marking (for example, crossing-out) or a color change or graphic change of the symbol.

Voice commands in the sense of the invention are not only actual commands according to a programming-related terminology. The invention can naturally be used for any language unit the user can put into a voice input system; that is, statements, words, commands, parameters, etc.

The invention relates to cases in which all currently or generally potential voice commands are visually displayed to the user as well as to cases in which only a selection of all currently or generally potential voice commands is displayed to the user.

Likewise, the invention relates to cases in which all currently or generally potential voice commands are acoustically issued to the user as well as to cases in which only a selection of all currently or generally potential voice commands is acoustically issued to the user.

According to a preferred embodiment of the invention, all visually displayed potential voice commands are also issued acoustically. The visual output and the acoustic output will then appear particularly consistent to the user.

However, it may also be advantageous for the quantity of acoustically issued potential voice commands to be lower than that of the visually displayed voice commands. As a result, the total duration of the acoustic output can be reduced. For example, the invention can be implemented such that only or particularly those voice commands are acoustically issued whose wording is difficult to gather from the visual presentation for inexperienced users. As an alternative, only or particularly those voice commands may acoustically issued which, according to expectations, are to be preferred in the current situation. On the system side, a corresponding selection can, for example, be made by means of the user's behavior in the past. As an alternative, only or particularly those voice commands can be acoustically issued which typically are used particularly rarely and with which the user is therefore not very familiar.

A similar approach can be used with respect to the sequence of the voice commands. Basically, the arranging sequence of the visual output, such as the sorting of a list, as well as the time sequence of the acoustic output can be varied individually or jointly in a context-sensitive manner. Thus, for example, those voice commands can be issued first or last whose wording is difficult to gather from the visual display by inexperienced users. As an alternative, for example, those voice commands can be issued first or last which, according to expectations, are to be preferred in the current situation. As an alternative, for example, those voice commands may be issued first or last which typically are used particularly infrequently and are therefore less familiar to the user.

According to a preferred embodiment of the invention, the time sequence of the voice commands in the acoustic output differs from the arranging sequence of the corresponding voice commands in the visual output. Thus, in the acoustic output, those voice commands may be issued first whose wording is difficult to gather from the visual display for inexperienced users; or those voice commands which, according to expectations, are to be preferred in the current situation; or those voice commands which typically are used particularly infrequently and are therefore less familiar to the user. In contrast, the arranging sequence of the visual output can be selected according to different criteria. Preferably, the arranging sequence of the visual output is selected such that the user can particularly rapidly and/or easily find his way in it. The visual output of a textual list may, for example, take place alphabetically. The two-dimensional visual output of a graphic desktop with symbols arranged on this desktop, independently of the situation, may always take place such that each symbol has a traditional place on this desktop, and the user can therefore determine very rapidly and easily whether the respective symbol or the pertaining voice command exists or is available in the current situation. Nevertheless, additional information may be supplied to the user by a suitable selection of the time sequence of the acoustic output. The information density of the entire output to the user can therefore be increased by the described embodiment of the invention without excessively burdening or confusing the user.

The simultaneous visual and acoustic presentation of potential voice commands according to the invention is preferably triggered by a user's action, for example, by operating a key or pronouncing a certain voice command, or by meeting of certain criteria within an input dialog. In the secondly mentioned case, for example, a preceding ambiguous or incomplete voice input may result in an “inquiry” of the voice input system. Several voice commands, which come close to a preceding ambiguous input, or several voice commands, which could complete a preceding incomplete input, can be issued to the user in the manner according to the invention.

The visual highlighting of a just acoustically issued voice command according to the invention can take place in multiple manners. In the case of a textual representation, for example, a change of color, bolding, underlining, framing, indenting or a marking arrow pointing to the text are conceivable.

The invention can be used in multiple fields of application. The invention is preferably used in a motor vehicle, and the voice input system is used for controlling at least one function of the motor vehicle. The visual output can then take place by an onboard monitor or a heads-up display of the motor vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1a is a schematic view of a first condition of the visual output of potential voice commands in a list form on an onboard monitor of a motor vehicle in a first variant of the invention;

FIG. 1b is a schematic view of a second condition of the visual output of potential voice commands in the first variant of the invention;

FIG. 2a is a schematic view of a first condition of the visual output of potential voice commands in a symbol form on an onboard monitor of a motor vehicle in a second variant of the invention;

FIG. 2b is a schematic view of a second condition of the visual output of potential voice commands in the second variant of the invention.

### DETAILED DESCRIPTION OF THE DRAWINGS

In a simple embodiment for illustrating the invention, it is assumed that only five voice commands are provided for controlling a car radio in a motor vehicle. The wording of the voice commands expected from the voice input system is “radio on,” “radio off,” “lower,” “louder” or “station selection.”

In a first variant of the invention, all potential, that is, available voice commands are visually displayed in a textual list. The output takes place by way of an onboard monitor 1 provided in the motor vehicle interior. When the user operates a HELP key provided in the motor vehicle interior, the potential voice commands are additionally issued acoustically. The potential voice commands are “read out,” as it were.

In the present simple embodiment, the acoustic output for informing the user is additionally preceded by the acoustic indication that “you have the following selection possibilities.”

In order to further support the user, the voice command which is just being issued acoustically is visually highlighted by a frame 2 in the visual display.

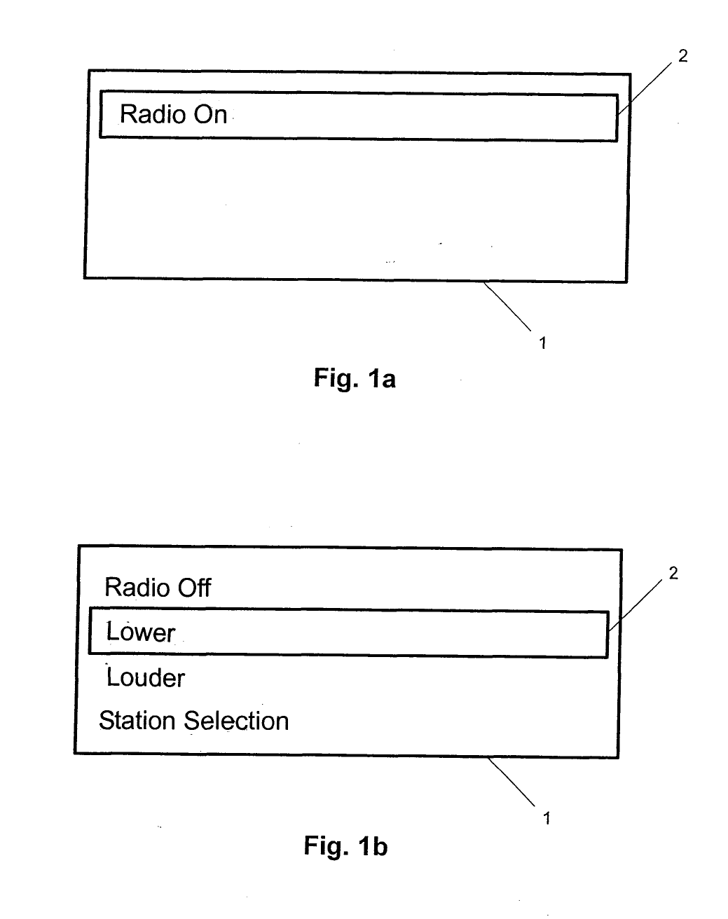

FIGS. 1a and 1b show two different conditions of the visual output on the onboard monitor 1.

When the radio is switched-off, only the “radio on” command is conceivable or available. The frame 2 illustrated in FIG. 1a only appears while this command is “read out.”

When the radio is switched on, the commands “radio off,” “lower” or “station selection” are conceivable or available. The four potential voice commands are acoustically issued in a successive manner. The respectively currently issued voice command is highlighted by a frame 2. In the present simple example, the time sequence of the acoustic output corresponds to the arranging sequence of the list on the onboard monitor 1. The frame 2 in FIG. 1b therefore “moves” downward during the reading-out of the voice commands on the onboard monitor 1, that is, from the first voice command by way of the second and the third to the fourth voice command. The condition illustrated in FIG. 1b (frame 2 around the “lower” voice command) of the onboard monitor 1 will last only as long as the duration of the reading-out of the “lower” voice command.

During the simultaneously occurring acoustic and visual output, the user can decide himself whether he wants to concentrate his attention on the acoustic output, on the visual output or on both outputs. The highlighting by means of the frame always indicates to the user at which point of the list the acoustic output has arrived.

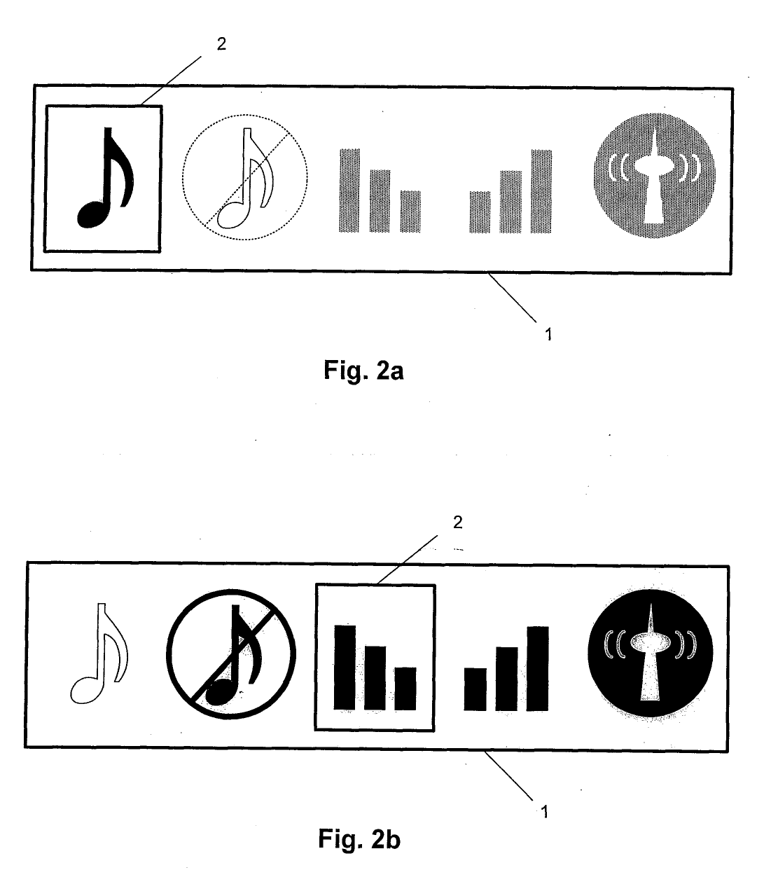

In a second variant of the invention, also potential, that is, available voice commands are visually displayed by symbols. The symbols of all voice commands generally provided for the control of the car radio have their fixed traditional place on the onboard monitor 1. The color intensity of the individual symbols, however, indicates to the user which voice commands are currently conceivable, that is, available (compare differences of the color intensity between FIG. 2a and FIG. 2b).

FIGS. 2a and 2b show two different conditions of the visual output on the onboard monitor 1.

When the radio (FIG. 2a) is switched off, only the “radio on” command is conceivable or available. It is visually represented by the symbol of a musical note. The symbols of the other voice commands, which are not available in the switched-off condition illustrated in FIG. 2a, are shown in lower color intensity.

When now—as in the first variant of the invention—the user operates the HELP key provided in the motor vehicle interior, the potential voice commands are issued acoustically. The wording of the voice commands in each case expected by the voice input system is issued acoustically.

In the switched-off condition, only the “radio on” voice command is conceivable. Only while this voice command is issued acoustically, will the frame 2 for the visual highlighting appear around the pertaining note symbol, which frame 2 is shown in FIG. 2a.

When the radio (FIG. 2b) is switched on, the commands “radio off,” “lower,” “louder” or “station selection” will be conceivable or available. The four pertaining symbols are now shown while the radio is switched on in full color intensity on the onboard monitor 1. In contrast, the symbol pertaining to the “radio on” voice command is shown in low color intensity because the voice command is currently not available.

When the HELP key is operated, the four potential voice commands are acoustically issued in a successive manner. The symbol pertaining to the respectively currently issued voice command is highlighted by a frame 2. In the present simple example, the time sequence of the acoustic output at first corresponds to the arranging sequence of the symbols on the onboard monitor 1. The frame 2 in FIG. 2b therefore “moves” during the acoustic output of the voice commands on the onboard monitor 1 from the left to the right; that is, from the second symbol by way of the third and the fourth to the fifth symbol. The condition illustrated in FIG. 2b (frame 2 around the symbol pertaining to the “lower” voice command) of the onboard monitor 1 will last only as long as the duration of the acoustic output of the “lower” voice command.

According to an alternative embodiment which will also be discussed by means of FIG. 2b, voice commands which the user has successfully used within a defined usage period (for example, one week) without using any help of the system (for example, the operation of the HELP key) are not issued acoustically. As a result of the thereby reduced acoustic output, the input dialog as a whole can be accelerated and the user is not “bothered” by an undesired help position. It is assumed that the “radio off” voice command is such a last successfully used voice command. Its wording is not issued acoustically because, on the basis of the successful use, it has to be assumed that the meaning of the command and the wording to be used are known to the user. The symbol in full color intensity pertaining to the voice command nevertheless indicates to the user additionally in a visual manner the availability of the voice command. The user is thereby reminded or he can make sure that he could use the voice command “radio off.”

It is assumed that the other voice commands “lower”, “louder” and “station selection,” which are available when the raid is switched on, were not last used successfully in the example. When the HELP key is operated, the wording of these three voice commands is therefore acoustically issued in a successive manner. The symbol pertaining to the respectively currently issued voice command is again highlighted by a frame 2. Here also, it is assumed for reasons of simplicity that the time sequence of the acoustic output corresponds to the arranging sequence of the symbols on the onboard monitor 1. The frame 2 in FIG. 2 therefore again “moves” during the acoustic output of the voice commands on the onboard monitor 1 from the left to the right, but this time only from the third symbol by way of the fourth symbol to the fifth symbol. The condition illustrated in FIG. 2b (frame 2 around the symbol pertaining to the “lower” voice command) of the onboard monitor 1 again lasts only as long as the duration of the acoustic output of the “lower” voice command.

As mentioned above, the time sequence of the acoustic output may also deviate from the arranging sequence of the symbols on the onboard monitor 1. Thus, for example, the voice command that had not been used for the longest time period can be acoustically issued first since, because the last use was so far in the past, it should be assumed that the user can least remember this wording. However, the arranging sequence on the onboard monitor 1 is intentionally maintained in order not to confuse the user. The highlighting of the just acoustically issued voice command by a frame 2 establishes the assignment between the acoustic and the visual output for the user.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of supporting the user of a voice input system by which a quantity of potential voice commands is visually issued to the user, wherein the voice commands are at least partially issued acoustically to the user in a successive manner and, during the acoustic output of a voice command, the same voice command is highlighted in the visual output.

2. Method according to claim 1, wherein the visual output at least partially takes place in a list form.

3. Method according to claim 1, wherein the visual output at least partially takes place in a symbol form.

4. Method according to claim 2, wherein the visual output at least partially takes place in a symbol form.

5. Method according to claim 1, wherein the visual output takes place at least partially in a text form by using abbreviations.

6. Method according to claim 3, wherein the visual output takes place at least partially in a text form by using abbreviations.

7. Method according to claim 1, wherein the time sequence of the voice commands in the acoustic output differs from the arranging sequence of the corresponding voice commands in the visual output.

8. Method according to claim 1, wherein the time sequence of the voice commands in the acoustic output is selected depending on the situation.

9. Method according to claim 8, wherein the arranging sequence of the voice commands in the visual output is defined independently of the situation.

10. Method according to claim 1, wherein the voice input system is used for controlling at least one function of the motor vehicle.

11. Method according to claim 10, wherein the visual output takes place by an onboard monitor or a head-up display of the motor vehicle.

12. A method of supporting the user of a voice input system, comprising the acts of:
visually issuing a quantity of potential voice commands to the user, wherein the voice commands are at least partially issued acoustically to the user in a successive manner, and
highlighting a voice command in a visual output during an acoustic output of the voice command.
